(19) United States
(12) Patent Application Publication
(10) Pub. No.: US 2007/0015287 A1
(43) Pub. Date: Jan. 18, 2007

(54) METHODS AND DEVICES FOR MEASURING ANALYTE CONCENTRATION IN A NONBLOOD BODY FLUID SAMPLE

(75) Inventors: David J. Robbins, Stevenson Ranch, CA (US); Charles G. Hwang, Ridgewood, NJ (US); Rebecca C. Eaton, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Remote Clinical Solutions, Inc., San Francisco, CA (US)

(21) Appl. No.: 11/457,408

(22) Filed: Jul. 13, 2006

Related U.S. Application Data
(60) Provisional application No. 60/699,978, filed on Jul. 15, 2005.

(51) Int. Cl. G01N 31/22

(52) U.S. Cl. 436/164

(57) ABSTRACT

Methods and devices for measuring analyte concentration in a nonblood body fluid sample enable rapid-results, low-cost diagnosis of various medical conditions in an outpatient setting. In one embodiment, measured patient sodium concentration is used by the patient or the patient's healthcare provider to guide medical decision-making. In another embodiment, measured patient sodium concentration is processed to mechanically adjust the concentration of sodium in an aqueous solution to be delivered to the patient for oral administration. In yet another embodiment, a closed loop system measures saliva sodium concentration and uses any of a number of different types of feedback control systems to monitor and control the fluid and/or electrolyte state of the patient.

### CROSS-REFERENCES TO RELATED APPLICATIONS

The present application claims the benefit of provisional U.S. Application No. 60/699,978 (Attorney Docket No. 022337-000400US), filed Jul. 15, 2005, the full disclosure of which is incorporated herein by reference.

### BACKGROUND OF THE INVENTION

1. Field of the Invention

The subject matter of this provisional application is related to that of copending provisional application No. 60/603,949 (Attorney Docket No. 022337-000200US), filed on Aug. 23, 2004, and copending provisional application No. 60/626,676 (Attorney Docket No. 022337-000300US), filed on Nov. 9, 2004, the full disclosure of which is incorporated herein by reference.

This application relates to methods and devices for determining the concentration of sodium in saliva.

Certain populations are particularly at risk for developing various fluid and electrolyte disorders—among them, hypernatremia (often seen in dehydration and characterized by elevated blood sodium levels), hyponatremia (characterized by low blood sodium levels), volume depletion, and edema—including independent seniors (for whom dehydration ranks among the top five most frequent causes for hospitalization; over 50% of those hospitalized die within 12 months as a result of medical complications), institutionalized seniors (of whom over 50 percent acquire hypo- or hypernatremia in a given 12-month period), young children (for whom dehydration resulting from gastroenteritis accounts for 10 percent of pediatric hospital admissions), post-surgical hospital patients (of whom between 5 percent and 15 percent develop hyper- or hyponatremia), professional and non-professional athletes (for whom dehydration of as little as 2 percent (dehydration of between 5 and 10 percent is common) can reduce athletic performance by as much as 20 percent), chronically-ill individuals (a number of chronic conditions, or medications for such conditions, precipitate dehydration, including diabetes and hypertension), military personnel (clinical studies demonstrate that there is a direct relationship be hydration status and the physical and cognitive performance of troops in the field), and mining and forestry personnel. Dehydration can lead to a number of serious medical complications, including renal failure, cardiac arrest, cerebral or pulmonary edema and death. If not treated in a timely fashion, mortality rates may exceed 50 percent. In 2000, the costs associated with dehydration-related hospitalizations among the 65+ demographic alone totaled $3.8 billion.

Dehydration, or risk thereof, is extraordinarily difficult to monitor. First, severe dehydration can occur very rapidly, in just a couple of hours. Second, many of the symptoms associated with dehydration (e.g. fatigue, confusion, dry mouth) do not appear until substantial fluids have been lost and medical complications take hold. Third, the symptoms of both hypernatremia and hyponatremia are similar, leading professional and informal caregivers to misdiagnose the condition and administer inappropriate treatment. Finally, many of the symptoms of dehydration may be present in normally-hydrated, at-risk individuals (among seniors, for example, a number of chronic conditions, and medications for such conditions, cause confusion; among athletes, anaerobic exercise often causes dry mouth and/or fatigue). The implication of the latter is that individuals at risk for dehydration, or their health care providers, often attribute classic signs of dehydration to other conditions and do not seek to correct the condition as a result.

In healthy individuals, the kidneys regulate fluid balance through serum sodium levels. Elevated serum sodium levels (as seen in hypernatremia) trigger the release of two hormones which cause the kidneys to retain water and sodium, thereby restoring intravascular volume. Depleted serum sodium levels (as seen in hyponatremia) shut off the release of these hormones, enabling the kidneys to excrete excess water. The implication here is that if an individual consumes too much or too little water or sodium, the kidneys automatically adjust. But in individuals with impaired renal function, the kidneys cannot retain or excrete the amount of water or sodium necessary to maintain fluid balance. For these individuals, a small imbalance in fluids and/or electrolytes can be life threatening.

Provided some sufficient amount of water is consumed, sodium replacement is the most important factor in achieving, and maintaining, effective fluid balance. Nonetheless, sodium replacement requirements vary dramatically across patient populations, and among individuals over time, based on a number of different environmental, physical, and behavioral factors—including heat, humidity, altitude, sweat rate, cardiovascular fitness, diet, alcohol and caffeine consumption, type or management of acute or chronic conditions, and genetic variations. That is, the standard deviation around the mean sodium replacement requirement is high; the National Athletic Trainers' Association defines the optimal oral rehydration solution as containing between 70 mg and 1266 mg of sodium per an 8 oz. solution.

Correcting fluid and electrolyte disorders is extraordinarily difficult. Because sodium replacement requirements are unknown, and vary dramatically across patient populations and intra-patient over time, individuals are left to formulate their own “best-guess” estimates of fluid and electrolyte replacement needs. These best-guess estimates are often inaccurate, as the deaths of Orioles pitcher Steve Bechler (2003), Minnesota Vikings offensive tackle Korey Stringer (2001), marathoners Rachel Townsend (2003), Cynthia Lucero (2002), and Kelly Barrett (1998), and a number of military trainees, among many others, bear testimony to.

The field of hydration monitoring and rehydration therapy is active. Its importance lies in facilitating early detection and correction. Ideally, at-risk patients, or their healthcare providers, would be able to frequently, inexpensively, and non-invasively measure hydration status, and corresponding sodium replacement requirements, and adjust oral or intravenous rehydration therapy accordingly, thereby keeping serum fluid and electrolyte levels close to normal physiological levels. Such a system would reduce medical complications and provide obvious increases in quality of life for at-risk patients.

It is known that information derived from biometric data, for example analyte levels in body fluids, may be employed to reliably predict the onset of, or to indicate the presence of, a fluid or electrolyte disorder in a human patient. For example, for patients presenting symptoms of fluid or electrolyte disorders, physicians will often order lab tests which measure any of a number of different clinical parameters in body fluids—most often in blood or urine—including: sodium concentrations, osmolality, blood urea nitrogen (BUN) levels, creatinine levels, BUN/creatinine ratios, hematocrit levels, protein levels, glucose levels, keytone levels, amylase levels, calcium levels, urate levels, chloride levels, albumin levels, and urine specific gravity. Other non-analyte measures used to improve the accuracy of diagnosis and to guide rehydration therapy include weight change, mucous membrane moistness, reported renal function, urine volume, urine color, tissue turgor, venous pressure, postural change in heart rate, postural change in blood pressure, body temperature, respiratory rate, heat rate, blood pressure, medication and medical history, recent environmental conditions (e.g. heat, exercise, etc.), recent change in functional ability (e.g. cognitive function, continence, etc.), fever/diarrhea/vomiting, and recent fluid intake. Serum osmolality and serum sodium concentration are considered the gold standard tests.

A major drawback of such tests is that: 1) they must be performed in a hospital setting (patients operating in an outpatient setting cannot monitor fluid balance and adjust rehydration therapy accordingly), 2) they are often invasive, 3) technicians specifically trained in blood handling are often required to perform the tests, 4) the tests must often be sent to a lab for processing (e.g. expensive lab equipment is required), and 5) time-to-test-completion is slow.

As a diagnostic fluid, saliva offers distinct advantages over serum. Saliva can be collected rapidly and non-invasively, with little training, at a fraction of the cost of blood, in an outpatient environment.

Clinical studies demonstrate strong correlations (mean r-0.94, P=0.01) between saliva osmolality and hydration status including, among others, a recent study conducted by the School of Sport, Health and Exercise Sciences at the University of Wales (“Saliva flow rate, total protein concentration and osmolality as potential markers of whole body hydration status during progressive acute dehydration in humans,” Archives of Oral Biology (2004) 49, 148-154).

It is generally understood that serum osmolality is primarily a function of serum sodium concentration. And clinical studies show direct correlations between serum osmolality and serum sodium concentration, including a recent study conducted by Doctors Alexander Kratz, M.D., Ph.D., M.P.H., Elizabeth Lee-Lewandrowski, Ph.D., M.P.H., and Kent B. Lewandrowski, M.D. from the Division of Laboratory Medicine, Department of Pathology, Massachusetts General Hospital and Harvard Medical School; Dr. Arthur Siegel, M.D. from the Department of Medicine, McLean Hospital, Belmont, Mass. and Harvard Medical School; Dr. Joseph Verbalis, M.D. from Georgetown University Hospital; Dr. Marvin Adner, M.D. from Metrowest Medical Center; and Dr. Terry Shirey, Ph.D. from Nova Biomedical Corporation (see FIG. 5).

Thus, there exists a need for a low-cost, non-invasive, rapid-results system that measures saliva sodium concentration, a marker for dehydration as well as a number of other fluid and electrolyte disorders.

2. Description of the Background Art

The sodium (Na+) effect on the activity of beta-galactosidase in the presence of other cations such as K+ and Mg²⁺ has been studied since at least 1950. Cohn and Monod (1951) investigated the action of various ions for enzymatic hydrolysis of lactose. The activity of monovalent cations was found to be complex. Depending on conditions such as the presence of certain other cations, Na+ can behave either as an inhibitor or as an activator. Monod et al. (1951) extended this work by investigating the effects of Na+ and K+ on beta-galactosidase inhibition by melibiose (an alpha-galactosidase).

Lederberg (1950) found that Na+ was conducive to the maximum rates of o-nitrophenyl beta-D-galactosidase (ONPG) hydrolysis. Kuby and Lardy (1953), however, stated that the effect of Na+ was nonvariant with substrate type, while Cohn and Monod (1951) found K+ promoted a greater hydrolysis rate when lactose was the substrate. The work of Reithel and Kim attempted to reconsider the monovalent cation effects of beta-galactosidase activity based on the hypothesis that previous studies were performed with non-homogeneous preparations of E. coli. They found that K+ is the most effective stimulator if lactose is the substrate. If oNPG is the substrate, then Na⁺ and Mg²⁺ must be present to obtain the maximum catalysis rate.

Becker and Evans (1969) found that Na+ affinity for beta-galactosidase was greater than that of K+ for oNPG and p-nitrophenyl Galactopyranoside (pNPG) and lactose. The activity of pNPG hydrolysis by K+ was inhibited by Na+. The activity of oNPG hydrolysis by Na+ was stimulated by K+. They concluded that the mechanism of Na+-mediated hydrolysis is different from the mechanism of K+ hydrolysis. Finally, Hill and Huber (1971) showed that beta-galactosidase can be inhibited by high concentrations of ions. This effect is reversible upon dilution. The Na+ activity profile has a broad peak for a given Mg²⁺ concentration.

Numerous patents have issued concerning the measurement of sodium concentration and the use of beta-galactosidase for this and other purposes. U.S. Pat. No. 4,649,123 describes a test means for determining the presence of an ion in an aqueous test sample, the test means comprising a hydrophilic carrier matrix incorporated with finely divided globules of a hydrophobic vehicle, said vehicle containing an ionophore capable of forming a complex with a specific ion to be determined, and a reporter substance capable of interacting with the complex of the ionophore and the ion to produce a detectable response. A continuation patent—U.S. Pat. No. 5,300,439—applies the technology to a test pad device. Specific ionophores, reporter labels, and hydrophilic polymers are listed. The test pad includes a chelator. This patent extends the use of the ionophore chemical reaction or binding events to a potential hand-held device. In contrast to the present invention, detection is accomplished via a hydrophobic reporter substance such as a phenol, an indophenol compound, a triphenylmethane, a fluorescein, a fluorescein ester, a 7-hydroxy coumarin, a resorufin, a pyren-3-ol, or a flavone (rather than via an enzymatic reaction), and the chemicals involved remain toxic and ill-suited for oral contact.

Similarly, U.S. Pat. No. 4,812,400 provides for a process for measuring the sodium concentration of a biological fluid, comprising the steps of supplying predetermined amounts of adenosine-5′-triphosphate (ATP), adenosine triphosphatase (ATPase), magnesium, and potassium in the presence of a buffer in a reaction mixture. In contrast to the present invention, the described assay uses the ATPase enzyme rather than the beta-galactosidase enzyme.

The use of beta-galactosidase for correlation of reaction result with sodium content has been known since at least 1971 (Hill, BBA 250: 530-537). U.S. Pat. No. 5,700,652 provides for a method for quantitative determination of sodium by reacting the sample with beta-galactosidase in the presence of potassium, cesium, and/or ammonium ions. The reaction occurs in the presence of a crown ether. The method specifically uses Cryptofix or lithium ion to prevent interference. U.S. Pat. No. 6,068,971 issued to Roche Diagnostics attempts to use the reaction described in U.S. Pat. No. 5,700,652 but first removes potential interfering materials. These patents utilize toxic substances to remove interferants and increase assay sensitivity, and measure change in color absorbance over time (delta A/minute). By contrast, the present invention quantitates saliva sodium concentration via a dual measurement of the distance along the length of a test element required to deplete the sample of sodium ions and reflectance at one or multiple irradiated zones, such dual measurement providing reduced interference and enhanced assay sensitivity.

There are several patents that describe saliva collection devices for diagnostic testing. Examples of these include U.S. Pat. No. 6,372,513, which describes a glass fiber pad with salt on it known to break down the mucous in saliva, and U.S. Pat. No. 5,922,614, which comprises a foam Q-Tip, whose sleeve squeezes the foam material to release the saliva sample.

U.S. Pat. No. 6,057,139 issued to McNeil-PPC, Inc. seeks to provide lactase (beta-galactosidase) tablets for consumption. In order to provide a stabilized product, it employs microcrystalline cellulose. The lubricants are used for pressing the active ingredient into a retained pill form. The patent has not prevented other manufacturers from using microcrystalline cellulose in their own lactase products. For example, Safeway commercializes its own lactase tablets, the container for which includes a disclaimer stating that the product is not manufactured or distributed by McNeil.

### REFERENCES CITED

U.S. Patent Nos. cited are U.S. Pat. Nos. 4,649,123; 4,812,400; 5,300,439; 5,700,652; 5,766,870; 5,992,614; 6,057,139; 6,068,971; and 6,372,513.

### Other Publications

1. Cohn M, Monod J. 1951 [Purification and properties of the beta-galactosidase (lactase) of Escherichia coli]. (Article in French). Biochim Biophys Acta. 7:153-174.
2. Monod J, Cohen-Bazire G, Cohn M. 1951. [The biosynthesis of beta-galactosidase (lactase) in Escherichia coli; the specificity of induction.] (Article in French). Biochim Biophys Acta. 7:585-599.
3. Reithel F J, Kim J C. 1960. Studies on the beta-galactosidase isolated from Escherichia coli ML 308. 1. The effect of some ions on enzymic activity. Arch Biochem Biophys. 90:271-277.
4. Lederberg J. 1950. The beta-d-galactosidase of Escherichia coli, strain K-12. J Bacteriol. 60:381-392.
5. Kuby, S. A. and Lardy, H. A. 1953. Purification and kinetics of D-galactosidase from Escherichia coli, strain K-12. J. Am. Chem. Soc. 75:890-896.
6. Becker V E, Evans H J. 1969. The influence of monovalent cations and hydrostatic pressure on beta-galactosidase activity. Biochim Biophys Acta. 191:95-104.
7. Hill J A, Huber R E. 1971. Effects of various concentrations of Na⁺ and Mg²⁺ on the activity of beta-galactosidase. Biochim Biophys Acta. 250:530-537.
8. Kay G, Lilly M D, Sharp A K, Wilson R J. 1968. Preparation and use of porous sheets with enzyme action. Nature 217:641-642.
9. Sharp K, Kay G, Lilly M D. 1969. The kinetics of beta-galactosidase attached to porous cellulose sheets. Biotechnol Bioeng. 11:363-380.
10. Lilly, M. 1971 Stability of Immobilized beta-Galactosidase on Prolonged Storage, Biotechnol Bioeng 13:589.
11. Brena B M, Ryden L G, Porath J. 1994. Immobilization of beta-galactosidase on metal-chelate-substituted gels. Biotechnol Appl Biochem. 19:217-231.

### SUMMARY OF THE INVENTION

The present invention provides both methods and devices for measuring the concentration of an analyte in a nonblood body fluid sample. In diagnostic systems, it is frequently found that the analyte of interest is present in the sample at a concentration that lies outside the range of sensitivity of the relevant analytical indicator enzyme, or that interference is caused by the presence of other ions to which the enzyme is also sensitive. For example, the range of sodium ion concentration to which the beta-galactosidase enzyme is most sensitive is lower than can conveniently be obtained in a plasma sample, or in certain saliva samples, without a dilution step. Prior art uses: 1) selective binding agents, such as Kryptofix.RTMM.221, to lower the effective sodium ion concentration to optimal levels for the beta-galactosidase enzyme, or 2) selective binding agents, such as Kryptofix.RTM.222, to reduce the free concentration of interfering ions such as potassium. A major drawback of these methods is that many of the selective binding agents contain highly toxic substances, making them ill-suited for handheld saliva tests. An additional drawback of these methods is that reaction conditions—which can influence the stimulatory or inhibitory effects of the selective binding agents—need to be highly controlled, whereas the latter is not always possible in an outpatient setting. The present invention avoids the above-mentioned problems.

A key feature of this invention is the determination of analyte concentration in a nonblood body fluid sample via a dual measurement of the distance along the length of a test element required to deplete the sample of analyte ions and reflectance at one or multiple regions along the test element, such dual measurement providing reduced interference and enhanced assay sensitivity. An additional element of the invention is the use of the enzyme beta-galactosidase immobilized on a diagnostic strip to reduce the free concentration of sodium ions to within the optimal range for the enzyme beta-galactosidase prior to, or during, quantitation of the sodium ion using this enzyme.

Apparatus according to the present invention comprise a non-toxic test element with a detection zone; a control unit which activates at least one light source to illuminate at least one region of the detection zone; a detection unit with detectors that measure light reflected from the detection zone, light transmitted through the detection zone, or electrical conductivity between points or regions along the detection zone; and an analytical unit that stores, processes, and analyzes data.

A sample collector may be integral to, attached to, or detached from the test element, often a chromatographic medium. With respect to a saliva or oral fluids sample, (hereafter referred to collectively as “saliva”), a sample collector may have any form suitable for absorbing or otherwise collecting the required saliva and subsequently delivering a dosed or undosed amount of the saliva alone, or together with a buffer, to the test element. For example, the sample collector may permit oral collection of saliva via sucking or licking. Exemplary saliva sample collectors include non-toxic, interference-free (non-analyte participating) materials such as bite-size sponges, pads, swabs, and filter paper. An expanding or non-expanding medium that absorbs only a predetermined (dosed) amount of saliva or a physical collection device that expresses or wrings from the sample collector a predetermined (dosed) amount of saliva may be used to deliver a measured amount of sample fluid to a buffer or test element. The device may further provide visual indications that the requisite amount of saliva has been collected and/or delivered.

A buffer or wetting agent may carry the analyte in the nonblood body fluid sample into the detection zone of the test element. The detection zone typically is in the solid phase and contains an immobilized enzyme, such as beta-galactosidase, which can react with the sample to produce a detectable signal representative of the presence of an analyte ion, such as sodium. A label for the enzyme, such as a calorimetric substrate, may be placed within a buffer or within the solid phase test element or both. As the buffer carries the sample along the detection zone of the test element, analyte in the sample reacts or binds with the enzyme or label located on the medium, thereby generating a visible color or other change. Lateral flow or other transport technology enables this calorimetric reaction to continue to advance across the entire detection zone, carrying the depleted sample with it.

Exemplary chromatography mediums include Whatman paper, silica gel on a nitrocellulose backing, agarose gel, or other filer paper. Exemplary buffers include various sodium-free aqueous components such as buffered DDI water or saliva matrix. Exemplary substrates include, among others, CPRG, X-Gal and ONPG, which respectively produce red, blue, and yellow colors upon reaction; selection will be based upon a number of factors, including color distinction, chemical stability, temperature stability, cost, and other factors.

When the analyte ions have been depleted from the sample, the enzyme on the detection zone and the associated calorimetric reaction, which can take the form of reaction bands or a reaction front, will no longer be activated. Analyte concentration in the sample is thus proportional to the distance the reaction bands or reaction front advance across the detection zone; the distance the reaction bands or front advance is used to generate a first detection signal. The systems may include various controls.

In order to facilitate depletion, the beta-galactosidase concentration in a solid phase chromatography medium need not be constant. The solid phase nearest the location of sample placement may contain higher concentrations of the enzyme, thereby facilitating rapid depletion of a portion of the analyte early in the chromatography procedure. Similarly, the solid phase nearest the end of the medium may contain lower concentrations of the enzyme, thereby stretching the physical distance that distinguishes medically interesting molar concentrations of analyte.

Measurement of the distance along the length of the detection zone required to deplete the sample of analyte ions may be accomplished through visual inspection, which may then be entered into the device by the end user, or through instrumentation.

Means for generating a second detection signal rely upon detecting light reflected from, or transmitted through, one or multiple discrete or overlapping points or regions along the detection zone at one or multiple wavelengths. Alternatively, means for generating a second detection signal rely upon detecting electrical conductivity at one or multiple discrete or overlapping points or regions along the detection zone.

The detectors transmit the first and second detection signals to the control unit and analytical unit, where the first and second detection signals, which may comprise one or multiple signals, are compared and analyzed to determine analyte concentration. Analyte concentration may subsequently be transmitted to a display unit, which displays analyte concentrations, and/or therapeutic recommendations, to the end user.

A number of different stabilizing additives, such as sucrose or microcrystalline cellulose, may be used to preserve the enzyme activity. Beta-galactosidase is found in food processing applications, including in the treatment of milk. Stability may be approached by immobilizing an enzyme to a solid phase support (Kay et al., 1968). The kinetics of immobilized beta-glactosidase have also been studied using Whatman paper as the support (Sharp et al., 1969). The long-term stability of immobilized beta-galactosidase has been studied and described (Lilly, 1971).

In order to equate analyte concentration to numerical values of analyte molarity, one or more controls, or parallel channels containing dosed analyte solutions, may be run simultaneously. If standard concentrations of analyte ions are run concurrently with body fluid samples, the buffer matrix must produce a result that correlates with the actual sample.

The present invention further provides methods for determining a level of dehydration in a patient based upon measured saliva sodium concentration.

The present invention further provides methods and devices for rehydrating patients. The methods rely on determining a level of hydration in the patient, where such determination is based upon saliva sodium concentration, and preparing a rehydration fluid by combining an amount of sodium with an aqueous agent, among other ingredients. Particularly, the methods provide that the amount of sodium to be combined is selected based on the determined level of hydration. The level of patient hydration is based upon measured saliva sodium concentration as described above. The rehydration fluid is then prepared by releasing a calibrated amount of sodium into the aqueous component, typically in a drinking vessel as described in U.S. Provisional Patent Application No. 60/603,949, “System and Method for Controlling the Fluid and Electrolyte State of a Patient,” the full disclosure of which has been previously incorporated by reference.

The present invention still further provides systems or devices including both the measurement devices described herein and the drinking systems described in application No. 60/603,949. A patient can use the measurement device to determine a level of hydration and, based on that level, calibrate the drinking device to combine the proper amount of sodium and/or other electrolyte(s) to provide a rehydration fluid intended to specifically address the individual level of hydration. The measurement device can be attached or otherwise coupled to the drinking device or may be detached. The sodium may be contained in a drinking cap, a drinking container, or in an electrolyte pouch that is opened by the user and poured into a drinking container.

The present invention has certain objects. That is, the present invention provides solutions to problems existing in the prior art. It is an object of the present invention to provide a device for accurately measuring analyte concentration in oral fluids in an outpatient setting without the use of toxic binding agents. It is an object of the present invention to provide a device for measuring saliva sodium concentration that is rapid, non-invasive, and low-cost, thereby enabling individuals to monitor fluid and electrolyte levels in an outpatient setting. Another object of the present invention is to diagnose various fluid and electrolyte disorders in an outpatient setting, thereby enabling patients to make informed healthcare decisions. Another object of the present invention is to provide a method for titrating fluid and electrolyte delivery based on actual fluid and electrolyte replacement needs, thus combining oral delivery therapies for administering fluid and electrolytes with monitoring technologies so as to effect tight control over the fluid and electrolyte level of a patient. The optimal intravenous or oral rehydration solution varies widely from patient to patient, and intra-patient over time, based on a number of different factors. The device of the present invention can measure sodium replacement requirements, enabling the dosing of a rehydration solution based on the unique biometric needs of the patient.

Various embodiments of the present invention have advantages, including one or more of the following: (a) enabling patients to diagnose various fluid and electrolyte disorders in an outpatient setting; (b) improving the direct or indirect control that may be exercised over the fluid and electrolyte levels of a patient; (c) quickly enabling the delivery of the required amount of sodium to a patient before hypernatremia, hyponatremia, volume depletion or edema develop or become life threatening; (d) overcoming the deficiencies of relying on “best guess” estimates of fluid and electrolyte replacement requirements, either or both of which are often under- or overestimated by patients; (e) reducing the number and severity of medical complications, thereby increasing patient safety and lowering health care costs due to better control of patient fluid and electrolyte levels.

Various embodiments of the present invention have certain features. In one embodiment of the present invention, measured patient saliva sodium concentration data is used to inform healthcare decisionmaking. In another embodiment, the device wirelessly or electronically transmits measured patient saliva sodium concentration data to a diagnostic or monitoring device either integral to or separate from the device of the present invention, which in turn generates a set of commands for a fluid and/or electrolyte delivery system. For example, the device of the present invention may be built into the mouthpiece of a container for drinking. A patient places his lips on the mouthpiece of the container, such action generates a saliva sodium concentration reading, such reading is transmitted to a receiving system which, based on the data transmitted from the device of the present invention, sends a series of commands to the delivery system, which then generates a series of recommendations or releases a proportional amount of beneficial agents contained in a retention pocket integral or attached to the container for drinking. In this embodiment, the control strategy of the device is preferably microprocessor based and/or implemented using dedicated electronics. Such a control strategy would enable the delivery system to generate patient data, such as fluid and/or electrolyte trends, which data may be used to further refine future calculations of fluid and/or electrolyte replacement needs.

By measuring saliva sodium concentration, and adjusting rehydration therapy based on this data, individuals can reduce the long-term threats associated with renal and cardiovascular complications. The methods and devices of the present invention constitute a reliable saliva sodium concentration measurement system that permits enhanced, tight control of patient fluid and electrolyte levels, among other medical conditions.

Additional objects, advantages, and embodiments of the invention will be realized by the methods and devices described in the written description and claims hereof, as well as from the appended drawings. It is to be understood that both the foregoing general description and the following detailed description are exemplary and are intended to provide further explanation of the invention claimed.

### BRIEF DESCRIPTION OF POSSIBLE EMBODIMENTS

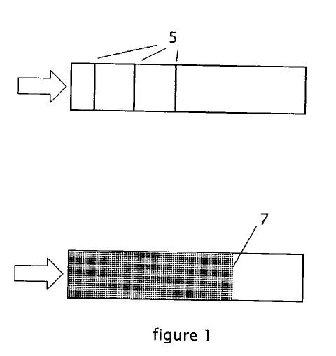

FIG. 1 illustrates two possible embodiments of the detection zone of a chromatographic test element. The arrow shows the direction of flow of sample liquid. In these embodiments, the detection zone of the test element contains a constant, or varying, concentration of an immobilized enzyme, beta galactosidase, whose activity is stimulated in the presence of the sodium ion, and a calorimetric substrate for the enzyme, chlorophenol red-BD-galactopyranoside (CPRG). The sample flows laterally across the detection zone, resulting in multiple reflectance bands 5 or leading edge front 7. The beta galactosidase is used to deplete the sample of sodium ion and to quantitate the concentration of sodium ion via a chromatographic reaction. The first detection signal is generated by determining the location of the bands 5 or leading edge front 7 relative to the location of sample placement on the detection zone. The second detection signal is generated by measuring the light reflected from, or transmitted through, bands 5 or leading edge front 7.

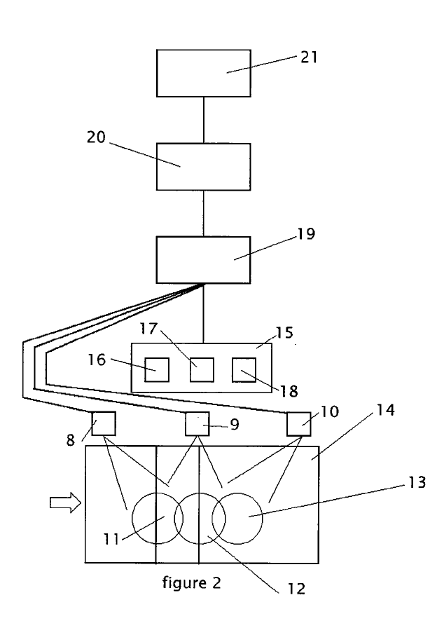

FIG. 2 shows a schematic block diagram of a device for the photometric analysis of test elements. The arrow shows the direction of flow of sample liquid in a chromatographic test element according to FIG. 1. In this example, the control unit 19 activates light sources 9 and 10 which are arranged such that they irradiate different, but overlapping, regions 12 and 13 on the detection zone 14. The control unit 19 activates light sources 9 and 10 in a wavelength range which is absorbed by the color formed in the detection zone when analyte ion is present. Irradiation of regions 12 and 13 may be timed so as to enable the measurement of the rate of sample analyte and enzyme reaction. The radiation transmitted through, or reflected from, region 12 and region 13 are detected by detectors 17 and 18 within detection unit 15 and transmitted to control unit 19 and analytical unit 20 where they are compared and analyzed to generate a first detection signal. The first detection signal is representative of the distance along the length of the detection zone 14 required to deplete the sample of analyte ions. In this example, the presence of a reflectance band in region 12 and the absence of a reflectance band in region 13 indicate that the sample was depleted of analyte ion between the reflectance bands of regions 12 and 13. The analytical unit 20 may use the first detection signal to determine the region at which the second detection signal is taken, in which case a command is transmitted to the control unit 19. In this example, the control unit may then activate light sources 8 and 9, and the radiation transmitted through, or reflected from, region 11 and region 12 are detected by detectors 16 and 17 and transmitted to control unit 19 and analytical unit 20 where they are compared and analyzed to generate a second detection signal. Analytical unit 20 compares the first detection signal with the second detection signal to determine analyte concentration and/or recommendations for a fluid and electrolyte delivery system. The calculated analyte concentration, and corresponding therapeutic recommendations, are then passed onto the display unit 21, which visually or acoustically displays the analyte concentration and/or recommendations.

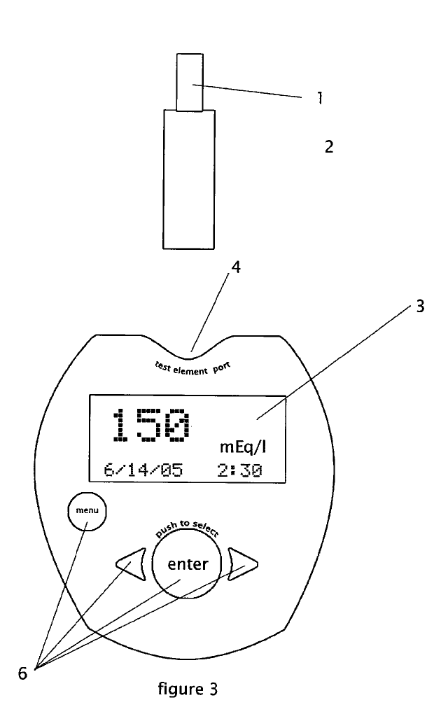

FIG. 3 illustrates one possible embodiment of the assembled device with user grip of test element 1, test element 2, a port 4 into which the test element is inserted for analysis, a display unit 3, and various control buttons 6, which enable end users to input patient data.

1. A method for the detemination of the concentration of an analyte ion in a nonblood body fluid sample, the method comprising the steps of:
placing a test element in a holder such that the detection zone of the test element is positioned relative to a detection unit;
contacting the detection zone of the test element with a nonblood body fluid sample such that a labeling system in the detection zone produces a photometrically-detectable label in the presence of the analyte;
detecting the distance along the length of the detection zone required to deplete the sample of analyte, which correlates with the analyte concentration of the sample, in order to generate a first detection signal;
detecting at least one of light reflected from the detection zone, light transmitted through the detection zone, or electrical conductivity along the detection zone, which correlates with the analyte concentration of the sample, in order to generate a second detection signal;
comparing the first and second detection signals, and determining analyte concentration based upon said first and second detection signals.

2. A method as in claim 1, wherein the nonblood body fluid is selected from the group consisting of exudates, transudates, and sweat.

3. A method as in claim 1, wherein the analyte ion is selected from the group consisting of sodium, potassium, calcium, magnesium, manganese, lithium, lead, zinc, copper, iron, chloride, or ammonium or substances that give rise to the formation of ammonium.

4. A method as in claim 1, wherein the labeling system comprises an immobilized enzyme whose activity is stimulated by the analyte ion and a colorimetric substrate for the enzyme.

5. A method as in claim 4, wherein the enzyme is beta D gaglactosidase.

6. A method as in claim 4, wherein the colorimetric substrate is selected from the group consisting of chlorophenol red-BD-galactopyrioside (CPRG), 2-Nitrophenyl-BD-galactopyranoside (ONPG), and 5-bromo-4-chloro-3-indolyl-BD-galactopyranoside (XGAL).

7. A method as in claim 1, wherein the detection zone of the test element contains constant or varing concentrations of the immobilized enzyme.

8. A method as in claim 1, wherein depleting the sample of analyte ions is accomplished through binding with the immobilized enzyme at one or multiple points or regions along the length of the test element.

9. A method as in claims 1, wherein detecting the distance along the length of the detection zone required to deplete the sample of analyte ions is accomplished via visual inspection.

10. A method as in claim 1, wherein detecting the distance along the length of the detection zone required to deplete the sample of analyte ions is accomplished via instrumentation.

11. A method as in claim 1, wherein the first detection signal and/or the second detection signal is adjusted based upon a control reading.

12. A method as in claim 1, wherein the first detection signal and/or the second detection signal is adjusted based upon patient data.

13. A method as in claim 12, wherein said patient data comprises weight, age, sex, body mass index, stature, chronic or acute conditions, environmental variables such as heat and humidity, and activity level.

14. A method as in claim 1, wherein the first detection signal and/or the second detection signal is adjusted based upon measured saliva flow rate.

15. A method as in claim 1, wherein the first detections signal and/or the second detection signal is adjusted based upon measured sample pH or temperature.

16. A method as in claim 1, wherein the first detection signal and/or the second detection signal is adjusted based upon measured rate of sample analyte and enzyme reaction.

17. A method as in claim 1, wherein the first detection sign and/or the second detection signal is adjusted based upon measured urea, creatinin, glucose, hematocrit, potassium, or magnesium levels in the body fluid sample.

18. A method as in claim 1, wherein the first detection signal and/or the second detection signal is generated one or multiple times.

19. A method as in claim 1, wherein the points or regions along the detection zone at which the first detection signal and/or the second detection signal are obtained overlap.

20. A method as in claim 1, wherein the points or regions along the detection zone at which the first detection signal and/or the second detection signal are obtained do not overlap.

21. A method as in claim 1, wherein the points or regions along the detection zone at which the second detection signal is obtained are fixed.

22. A method as in claim 1, wherein the points or regions along the detection zone at which the second detection signal is obtained depend upon the first detection signal.

23. A method as in claim 1, wherein the points or regions along the detection zone at which the second detection signal is obtained depend upon prior detection signals.

24. A method as in claim 1, wherein the points or regions along the detection zone at which the second detection signal is obtained depend upon control readings.

25. A method as in claim 1, wherein the points or regions along the detection zone at which the second detection signal is obtained depend upon patient data.

26. A method as in claim 25, wherein said patient data comprises weight, age, sex, body mass index, stature, chronic or acute conditions, environmental variables such as heat and humidity, and activity level.

27. A method as in claim 1, wherein the points or regions along the detection zone at which the second detection signal is obtained depend upon stored analyte readings.

28. A method as in claim 1, wherein the first detection signal and/or the second detection signal is obtained at one or multiple wavelengths.

29. A method as in claim 28, wherein the wavelength at which any given detection signal is obtained is fixed.

30. A method as in claim 28, wherein the wavelength at which the second detection signal is obtained depends upon the first detection signal.

31. A method as in claim 28, wherein the wavelength at which any given detection signal is obtained depends upon prior detection signals.

32. A method as in claim 28, wherein the wavelength at which any given detection signal is obtained depends upon control readings.

33. A method as in claim 28, wherein the wavelength at which any given detection signal is obtained depends upon patient data.

34. A method as in claim 33, wherein said patient data comprises weight, age, sex, body mass index, stature, chronic or acute conditions, environmental variables such as heat and humidity, and activity level.

35. A method as in claim 28, wherein the wavelength at which, any given detection signal is obtained depends upon stored analyte readings.

36. A method as in claim 1, wherein the second detection signal comprises one detection signal selected among one or multiple signals.

37. A method as in claim 36, wherein the selection of one signal among in multiple, signals is based upon lowest intensity.

38. A method as in claim 36, wherein the selection of one signal among multiple signals is based upon highest intensity.

39. A methods as in claim 1, wherein the second detection signal comprises a change in two or multiple signals measured at different points or regions along the detection zone of the test element.

40. A method as in claim 1, wherein the second detection signal comprises multiple detection signals.

41. A device for the determination of the concentration of an analyte ion in a nonblood body fluid sample comprising:
a test element with a detection zone, said detection zone having a labeling system which produces a photometrically-detectable label in the presence of the analyte;
a control unit which activates at least one light source to illuminate at least one point or region of the detection zone of the test element;
a detection unit with at least one detector which detects the distance along the length of the detection zone required to deplete the sample of analyte ions, which correlates with the analyte concentration of the sample, in order to generate a first detection signal; and at least one additional detector which detects at least one of light reflected from the detection zone, light transmitted through the detection zone, or electrical conductivity along the detection zone, which correlates with the analyte concentration of the sample, in order to generate a second detection signal;
an analytical unit which compares the first and second detection signals to determine an analyte concentration in a sample.

42-99. (canceled)
